(19) United States
(12) Patent Application Publication
(10) Pub. No.: US 2012/0150616 A1
(43) Pub. Date: Jun. 14, 2012

(54) System and Method for Mass Non-Revenue Binding Retail Negotiation

(75) Inventor: Paul Sitbon, Paris (FR)

(73) Assignee: WIKIFUN, INC., Palo Alto, CA (US)

(21) Appl. No.: 13/323,810

(22) Filed: Dec. 12, 2011

Related U.S. Application Data
(60) Provisional application No. 61/422,290, filed on Dec. 13, 2010.

(51) Int. Cl. G06Q 30/02

(52) U.S. Cl. 705/14.35; 705/14.1

(57) ABSTRACT

A method for mass non-revenue binding retail negotiation. The method comprises identifying a targeted geographic area and selecting a plurality of merchants within the targeted geographic area and having a product or service in common. The method continues by assigning a package to the plurality of merchants in order to receive an offer from the plurality of merchants for the assigned package. The method includes receiving a plurality of offers for the package, applying a criteria to each offer received from the plurality of merchants in order to provide feedback to each merchant that provided an offer from the plurality of merchants. Receiving a final offer from the plurality of merchants and selecting at least one final offer received from the plurality of merchants.

### PRIORITY STATEMENT

This application claims the benefit of U.S. Provisional Patent Application Ser. No. 61/422,290 filed Dec. 13, 2010, which is hereby incorporated by reference herein in its entirety.

### BACKGROUND OF THE INVENTION

1. Field of the Invention

The present invention relates to retail negotiation, and more specifically to a system and method for generating competition between a plurality of merchants within a targeted geographic location and similar product or service offerings to obtain and select at least one offer for a good or service for the selected targeted geographic area and the selected product or service.

2. Description of the Related Art

There are many well known systems and methods for offering goods and services of merchants at a discount on a network including but not limited to the Internet. One well known method contemplates the sales of goods and services being contingent upon a quantity of actual sales. The quantity of sales may often be referred to as a tipping point. The tipping point provides the merchant with a guaranteed minimum number of sales of the goods or services. Otherwise, if the tipping point is not met, the merchant is not required to honor any discount that was negotiated based on the tipping point. This well known system provides the consumer with a discount for the purchase of goods or services and the merchant with a minimum number of sales at a discounted price.

According to the above system, a merchant is selected to participate in discount retailing. Alternatively, the merchant may request to have its goods or services offered. Once the merchant is selected, the next step may involve determining the terms of an offer for the product or service the merchant is able to provide. The terms may include duration of the offer, maximum number of the goods or services the merchant is willing to offer for sale, expiration of the offer, etc.

After the discount offer and terms are negotiated with the merchant, the discount offer is made available to potential consumers. The discount offer may be made available through a global communication network, such as the Internet. If the number of potential consumers that participate by accepting the discount offer does not reach the tipping point in a fixed amount of time, then the offer is rescinded or rejected, the consumer is not charged for the purchase, and the merchant does not receive a payment.

A disadvantage associated with the above well known method includes a minimal revenue commitment to the merchant. If the revenue condition or the tipping point is not met, then the discount is not valid. Additionally, this approach includes negotiation with one merchant on an individual basis. In order to provide various discounts from a plurality of merchants, many one to one negotiations have to take place which may be time consuming and may not result in the best retail discount for the potential consumer. This method does not lend itself to automated negotiation on a large scale basis with multiple merchants in multiple locations for multiple products and services.

There is currently a need in the art for a system and method capable of generating competition for an offer to provide a good or service by comparing offers between a plurality of merchants within a targeted geographic area without requiring or guaranteeing a minimum quantity of sales for the offer to be valid. There is also a need in the art for a system and method of automatically negotiating discount offers in multiple geographic areas for multiple products and services.

### SUMMARY OF THE INVENTION

According to an aspect of the present invention, a method for negotiating an offer for a package is provided. The method is performed using a processor. The method includes selecting a targeted geographic area, then identifying the package to be offered, and labeling the package offered with a business category. The method continues with associating the package to a plurality of merchants that match the business category of the package offered and are located within the selected targeted geographic area. The method continues with receiving a plurality of offers for the package from the plurality of merchants and selecting at least one offer.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a flow chart for defining a targeted geographic area according to an exemplary embodiment of the present invention;

FIG. 2 illustrates an exemplary computer network according to the present invention;

FIG. 3 illustrates another flowchart for configuring and assigning a package; and

FIG. 4 illustrates a flow chart for online negotiation sessions.

### DESCRIPTION OF THE EMBODIMENTS

Various exemplary embodiments, features, and aspects of the invention will be described in detail below with reference to the drawings.

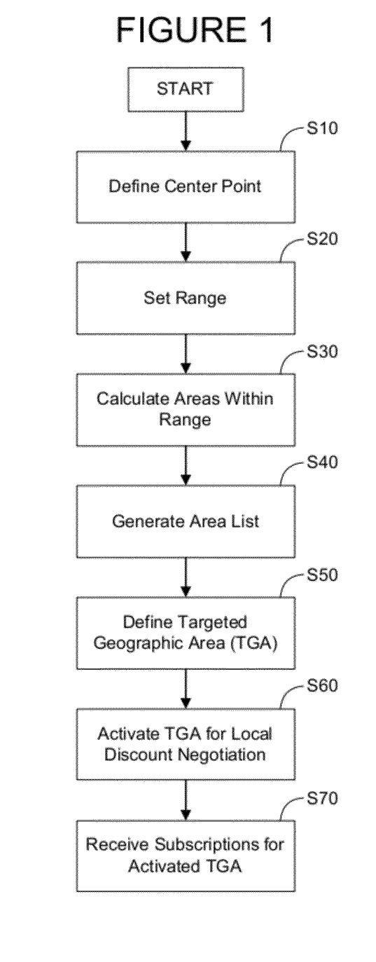

The present invention is directed to a system and method for mass non-revenue binding local discount negotiation. A first phase of the mass non-revenue binding local discount negotiation includes preparing and activating a targeted geographic area for competition and communication management. Referring now to FIG. 1, a flow chart is provided which illustrates steps for preparing and activating a targeted geographic area (TGA). In step S10, a center point is defined. The center point may be an area code, street, zip code, city, county, state, or country by way of example and not of limitation. An administrator of the system and method for mass non-revenue binding local discount negotiation in step S10, would enter for example, a city to be defined as the center point. The administrator may enter the center point according to step S10, using a computer, mobile device, or electronic device that is configured to execute a program and communicate with a network.

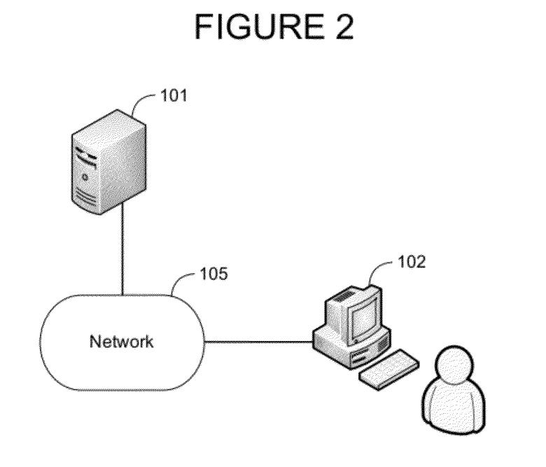

Referring now to FIG. 2, an exemplary diagrammatic illustration of a system configuration according to an exemplary embodiment of the present invention is shown. In FIG. 2, a network 105 is, for example the Internet or an intranet. Network apparatuses such as a server 101 and a client personal computer (PC) 102 are connected to the network 105. The client PC 102 is a client computer. Although not illustrated, a plurality of client PCs can be connected to the network 105.

Various control programs of the server 101 and the client PC 102 of the exemplary embodiments illustrated in the flowcharts described below are stored in either a memory or a storage device of the corresponding apparatus, and executed by a CPU of the respective apparatuses. The server 101 includes a database for document management. The database is also included in the storage device.

The mass non-revenue binding local discount negotiation includes accessing a program by merchants and consumers using client PCs. Both the merchants and consumers provide information via the program. The program may be a website or a mobile application by way of example. If the program is a website, the merchant and consumer can access the website using a Web Browser. Alternatively, a mobile application can be downloaded and executed on a mobile phone or computing tablet to execute the program. Additionally, a program may be downloaded onto a computer that is executed on the operating software of the computer to allow merchants and consumers to communicate information and preferences to proceed with mass non-revenue binding local discount negotiations.

Referring back to FIG. 1, after the center point for the TGA is selected instep S10, a distance range is set instep S20. For example if a city is selected as the center point, a ten mile distance range may be selected. This would result in a ten mile radius being set as the distance range from the city that was defined as the center point in step S10. In this example the TGA includes the area within a ten mile radius of the center point which is the selected city. A ten mile distance range was set here as an example, any distance may be selected.

In step S30 of FIG. 1, all the areas within the distance range provided in step S20 are calculated. Subsequently, in step S40 a list of areas is generated from the calculation in step S30. The list of areas may be a list of zip codes, cities, or streets byway of example. In the example provided above, a city was defined as the center point, so a list of cities may be generated that are within the area calculated in step S30.

In the next step S50 the list of areas generated in step S40 are defined as the TGA. In step S60, the TGA is activated for local discount negotiation. Step S70 includes receiving subscription for the activated TGA. In other words, the system allows merchants that would like to offer a product or service by negotiating a discount to subscribe to an activated TGA in which the merchant conducts business within.

The second phase of the mass non-revenue binding local discount negotiation includes configuring and activating packages, matching merchants with the configured packages in a TGA. This feature allows for automated matching combined with consumer and merchant contributions to select merchants for each package in the TGA. The system and method uses search and enhancement technologies to identify potential merchants for a given category in a specific TGA. The merchants have the ability to select their relevant business categories.

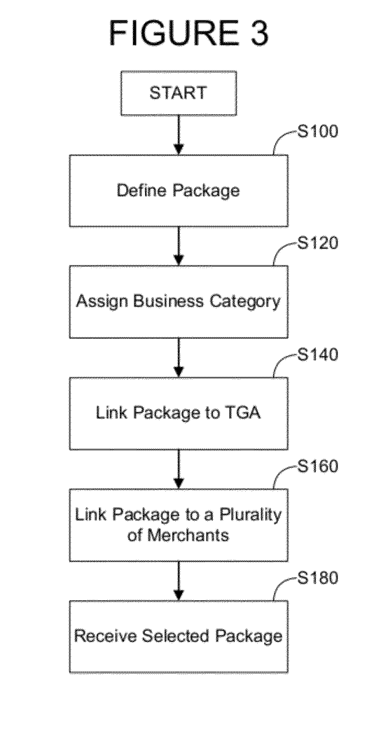

Referring now to FIG. 3, a flow chart is provided which illustrates a process for configuring a package for a good or service. The flow chart begins with step S100 of defining a package. The package maybe for a good or service offered by a merchant. For example, a service such as a therapeutic massage offered by a merchant is considered a package. After the package is selected in step S100, the package is assigned a business category in step S120. The business category for the example above would be spa services for the therapeutic massage package.

After the package is assigned a business category in step S120, the package is assigned to a TGA in step S140. Subsequently, in step S160 the package assigned to the TGA in step S140 is sent to merchants that are located within the TGA by default based on a matching of the business category. The package may be sent via email by way of example and not of limitation. This matching may be done through information that is provided by the merchant, information that is scraped using a web scraper program via the Internet, or information provided by users or consumers that are familiar with the merchant. In this regard, the information may be stored on a database or a web server. The merchant is able to log into a website or database and provide information such that a program employing automated matching techniques may assign a particular package for a good or service to the merchant. This requires search and enhancement technologies to identify potential merchants for a given business category/package in a specific TGA. In step S180 an option for selecting the package is provided to the merchant. If the merchant selects the package, then local discount negotiation may be initiated with the merchant. Alternatively, if the merchant does not select the package, then the merchant is excluded from negotiating a discount on the package.

The next phase of the mass non-revenue binding local discount negotiation includes performing online local negotiation sessions. This allows for automatic selection of a merchants offer for a package.

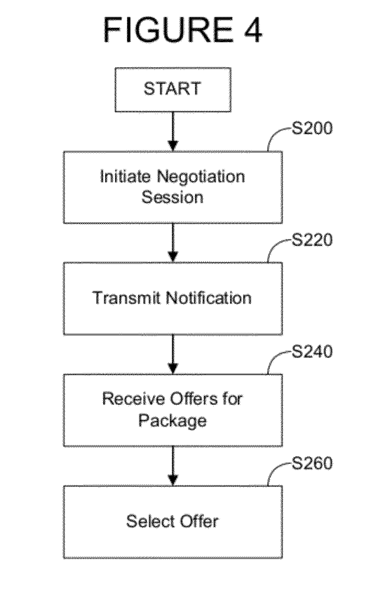

Referring now to FIG. 4, a flow chart illustrating the steps associated for an online negotiation session is provided. In step S200 an online negotiation session is initiated. The negotiation session may be initiated by sending an e-mail to merchants that have at least one package assigned to them as shown in step S220. The e-mail may include a link the merchant can select in order to begin negotiating. While an e-mail may be used to notify the merchant other methods are contemplated including messages through social media, SMS messages, etc. In step S240, the merchant submits a discount offer for the package assigned. Other terms may also be included. After step S240, the offer for the package is received from a plurality of merchants as provided in step S260. The best offer may then be selected for the assigned package as provided in step S280.

The system and method for mass non-revenue binding retail negotiation allows for a plurality of merchants to be selected based on a TGA. Then a particular business category is selected to further narrow the amount of merchants negotiating on a package that the merchants would like to offer for sale. After the offers are received, the best offer for the assigned package is selected.

In one embodiment of the present invention, after step S260 wherein the offers from the plurality of merchants are received, instead of selecting the best offer for the package as shown in step S280, a threshold is calculated based on the offers received for the package. After the threshold is calculated, feedback is sent back to the merchant to notify the merchant if the offer provided by the merchant meets the threshold. If the offer provided by the merchant does not meet the calculated threshold, the offer will not be selected. The merchant will then have the opportunity to submit a final offer for the package or withdraw from the online negotiation session.

The feedback provided to the merchant can include the probability that the offer will be selected. The merchant can be notified that based on the selection criteria in combination with offers received from other merchants, the merchants offer is or is not likely to be selected. A fixed time is provided for the merchant to provide a final offer after receiving the feedback regarding the initial offer. An administrator of the system may approve the selection of the local discount that was selected. Upon selection, dates are automatically assigned to the local discount with options for an administrator to amend.

The next phase of the mass non-revenue binding local retail negotiation includes developing extensive communications in the TGA through various automated media production systems. This includes defining media parameters, generating media, and communicating the same to potential consumers. Defining media parameters is initiated with the selection of an active TGA for media production. Then a time period is selected for which the media is produced. Then different levels are assigned to business categories so display in printed media is consistent. The system contemplates automatically generating a file with database content to be displayed on media with all relevant coupons applicable to the TGA in the selected period. Dates are included when the discount coupons can be purchased or are applicable. The file may then be converted into various forms of media such as eMagazines, printed magazines, e-mail byway of example and not of limitation. Finally, the coupons are communicated via e-mail, mobile devices, eMagazines, printed paper, social media.

The TGA may also be used to send location based information to other social media platforms such as Twitter or Facebook by way of example. For example, all cities within a TGA may be assigned to a unique account on another website or social media platform to which users can identify themselves within respect to a specific metropolitan area. For example, a Twitter account referring to Dallas will concentrate all information related to the Greater Dallas TGA with central Dallas as the center point. Using that methodology allows for the assignment of hundreds of thousands of cities to a few hundred TGA related Twitter accounts within a very short timeframe, thus enabling automated structured communication with the public anywhere.

The next phase of the mass non-revenue binding local retail negotiation includes selling the discount packages to the consumers and paying merchants. The sale process may be initiated by some form of communication such as email to users. Users then navigate to a discount coupon purchase page possibly via a web browser. Then payments are processed with recording of the transaction. Then the voucher is generated with coupon terms to the consumer. Then the merchant may receive the payment after the purchase by the consumer is made.

A potential consumer may view various discount packages via a web browser by selecting a TGA via a pulldown menu. The system and method of the present invention provides an online resource that both merchants and consumers may access to provide information. A merchant may enter information about its customer base and a program can generate multiple discount schemes that the merchant may then select or amend. The discounts can be displayed on a website with limit dates that are consistent with the merchant's requested preferences.

The above methodology presents the advantage of a wider and easier application since discount packages are set from the start for potential consumers. Therefore there is no need to manage situations where minimal revenue is not met for a specific discount, or where user commitments should be tradable for alternate deals. The methodology requires advanced competition systems in order to identify the most competitive merchant given the non-revenue binding agreement. This requires highly structured data in order to enable systematic matching of packages with relevant local merchants. It also requires advanced communication systems in order to distribute information on the deal extensively.

Delivering high quality local discount coupons with no minimal revenue guarantee therefore requires the ability to create competition between local companies providing similar services on standard packages. By selecting the highest quality discount coupons, an organization can provide highest value to larger numbers of local clients, which in turn generates strong increases in revenue for the selected local companies. By leveraging communication, the requirement to condition the discount to meeting a minimal amount of sales is no longer necessary. Performance being a key criteria for high conversion rates, this approach for generating competition between potential providers for the good or service is advantageous.

A database of local merchants and the ability to communicate directly with these local merchants is contemplated. The ability to allow these companies to self manage their own information, and specifically assign business categories to their profile allow for automated local negotiation between participating merchants. Furthermore, the ability to create a virtual representation of a targeted geographic area based on local population and business footprint is another advantage. The ability to select local organizations within targeted geographic areas and then define relevant packages for which local competition can be created between organizations within a defined targeted geographic area lends itself to a global platform for negotiating discounts in multiple business categories. The ability to associate relevant business categories to the packages in order to select merchants with matching business categories and enable competition on a common basis for relevant companies within the geographic area, the ability to receive user reviews online for providers' service quality assessment, and the ability to provide an online interface for competing merchants to provide pricing, maximum sales quantity, and other details for the proposed package during a fixed period of time. The ability to provide online multiple criteria (including user reviews) real time feedback to competing merchants in order to provide objective multiple party feedback for competitive pricing for selected packages within each category and each geographic area. The ability to select highest quality offers based on the multiple criteria at closing of the online negotiation session and inform all parties of selected and non-selected discount pricings.

Building the entire process above, and replicating it on multiple targeted geographic areas with local companies in local language, creates a global platform running simultaneously multiple local negotiation sessions for multiple packages in multiple business categories in multiple geographic areas. For example the process can be applied to 5000 targeted geographic areas worldwide for the selection of 90 daily discount coupons for the following month (3 per day) in each targeted geographic area. By enabling competition between an average of 10 merchants for each package, the system would be generating simultaneous local negations between 5000 areas×90 packages×10 competing companies results in 4.5 million simultaneous negotiations with very limited local support required.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. A method for negotiating an offer for a package, the method being performed by a processor, the method comprising:
selecting a targeted geographic area;
identifying the package to be offered;
labeling the package offered with a business category;
associating the package to a plurality of merchants that match the business category of the package offered and are located within the selected targeted geographic area;
receiving a plurality of offers for the package from the plurality of merchants; and
selecting at least one offer for the package.

2. The method according to claim 1, wherein the plurality of offers received from the plurality of merchants are compared to each other in order to transmit feedback to the plurality of merchants based on the comparison of the plurality of offers.

3. The method according to claim 1, wherein the package is a product or service.

4. The method according to claim 1, wherein the targeted geographic area is based on any one of street, area code, city, zip code, county, state, country.

5. The method according to claim 1, wherein information about the plurality of merchants is stored in a database.

6. The method according to claim 5, wherein the information for each merchant is edited by a user.

7. The method according to claim 5, wherein each merchant from the plurality of merchants within the database has a merchant profile and the ability to manage their merchant profile.

8. The method according to claim 7, wherein the package assigned to each merchant is based upon information provided by the merchant in their merchant profile.

9. The method according to claim 1, wherein each offer received for the package includes a fixed time limit.

10. The method according to claim 1, wherein each offer is compared to determine the offer with the greatest value.

11. The method according to claim 1, wherein the feedback provided to the merchant includes a likelihood of the offer being selected.

12. The method according to claim 1, wherein a plurality of targeted geographic areas are selected so that the method for negotiating the offer for the package is processed for each of the targeted geographic areas selected.

13. A method for automated negotiation in multiple targeted geographic areas for multiple business categories, the method being performed by a processor, the method comprising:
selecting a plurality of targeted geographic areas;
identifying a plurality of merchants for each targeted geographic area;
assigning a package for each targeted geographic area;
labeling each package for each targeted geographic area with a business category;
associating each package to a plurality of merchants that match the business category of the package offered for each targeted geographic area;
receiving a plurality of offers for each package; and
selecting at least one offer for each package in each targeted geographic area.

14. The method according to claim 13, wherein the plurality of offers received from the plurality of merchants are compared to each other in order to transmit feedback to the plurality of merchants based on the comparison of the plurality of offers.

15. A system for negotiating an offer for a package, the system comprising:
a selection unit for selecting a targeted geographic area;
an identifying unit configured to identify the package to be offered;
an assigning unit configured to assign the package to a plurality of merchants that are capable of providing the package and are located within the selected targeted geographic area;
a receiving unit configured to receive a plurality of offers for the package;
a comparison unit configured to compare the plurality of offers;
a transmission unit configured to transmit feedback to the plurality of merchants based on the comparison of the plurality of offers,
wherein the receiving unit receives a plurality of final offers for the package and selects at least one final offer.
